(19) United States
(12) Patent Application Publication
(10) Pub. No.: US 2025/0087680 A1
(43) Pub. Date: Mar. 13, 2025

(54) NEGATIVE ELECTRODE ACTIVE MATERIAL AND ALL SOLID BATTERY

(71) Applicant: TAIYO YUDEN CO., LTD., Tokyo (JP)

(72) Inventors: Taiki SUEMATSU, Tokyo (JP); Daigo ITO, Tokyo (JP)

(73) Assignee: TAIYO YUDEN CO., LTD., Tokyo (JP)

(21) Appl. No.: 18/580,504

(22) PCT Filed: Mar. 14, 2022
(86) PCT No.: PCT/JP2022/011243

§ 371 Date: Jan. 18, 2024

(30) Foreign Application Priority Data
Aug. 6, 2021 (JP) 2021-129492

(51) Int. Cl. H01M 4/485; C01G 35/00

(52) U.S. Cl. CPC H01M 4/485; C01G 35/00; C01P 2002/50; C01P 2002/76; C01P 2004/61; C01P 2004/62; C01P 2006/40

(57) ABSTRACT

A negative electrode active material is expressed by a composition formula of TiTa₂₋ₓMₓO₇. x is less than 0.20. Ti/(Ta+M) ratio is 0.50 or more and 0.56 or less.

### TECHNICAL FIELD

The present invention relates to a negative electrode active material and an all solid battery.

### BACKGROUND ART

In recent years, all solid batteries have been used as secondary batteries with high energy density. Electrode active materials for use in all solid batteries are being developed (for example, see Patent Document 1).

### PRIOR ART DOCUMENT

### Patent Document

Patent Document 1: International Publication No. 2014/038311

### Non-Patent Document

Non-Patent Document 1: Mat. Res. Bull. 48 (2013) 2702-2706.

### DISCLOSURE OF THE INVENTION

### Problems to be Solved by the Invention

In recent years, secondary batteries have been used in various fields. Secondary batteries using liquid electrolyte have problems such as electrolyte leakage. Therefore, all solid batteries are being developed that are equipped with a solid electrolyte and other components are also made of solid materials. Solid electrolytes have a wider potential window (stability over a wide range of potentials) than liquid electrolyte. In particular, oxide-based solid electrolytes that exhibit high ionic conductivity through sintering have the advantage of having a wider potential window and being relatively stable in the atmosphere compared to liquid electrolyte-based and other solid electrolyte-based systems.

The characteristics required of electrode active materials applied to all solid batteries using oxide-based solid electrolytes include that mutual diffusion reactions are difficult to occur when co-sintered with a solid electrolyte, and changes in volume due to charging and discharging are small, in addition to basic battery characteristics such as Coulombic efficiency, cycle characteristics, and capacity. Furthermore, in the case of the negative electrode active material, it is required that the negative electrode active material is an oxide-based active material that exhibits a small change in volume during charging and discharging, and that can perform charging and discharging operations at a sufficiently low operating potential. In particular, in an all solid battery using an ultra-small oxide-based solid electrolyte, the negative electrode active material is required to have a high volumetric specific capacity, high stability in batch firing, and good cycle characteristics.

Non-Patent Document 1 reports the research results of a TiTa₂O₇ compound, which is an oxide-based negative electrode active material that has a high volumetric capacity and can operate down to a low potential of 1V vs. Li/Li⁺. However, the Coulombic efficiency of TiTa₂O₇ is less than 50%, and the cycle characteristics of TiTa₂O₇ are such that the capacity retention rate falls below 50% within 10 cycles. A Ti—Ta—O compound that operates at a low potential, has a high volume specific capacity, and has excellent coulombic efficiency and cycle characteristics is desired.

The present invention was made in view of the above problems. An object of the present invention is to provide a negative electrode active material that is capable of operating at a sufficiently low potential, has both high volume specific capacity and good cycle characteristics, can be co-fired with a solid electrolyte in a wide firing temperature range and is suitable for an all solid battery using an oxide-based solid electrolyte. Moreover the object is to provide an all solid battery using the negative electrode active material.

### Means for Solving the Problems

A negative electrode active material of the present invention is expressed by a composition formula of TiTa₂₋ₓMₓO₇, characterized in that: x is less than 0.20; and Ti/(Ta+M) ratio is 0.50 or more and 0.56 or less.

The above-mentioned negative electrode active material may have a monoclinic structure belonging to a space group I2/m.

The above-mentioned negative electrode active material may have capacitive components in two potential ranges of 1.1V or more and 1.2V or more vs. Li/Li⁺, and 1.6V or more and 1.8V or less vs. Li/Li⁺.

In the above-mentioned negative electrode active material, x may be 0.

An all solid battery of the present invention is characterized by including: an oxide-based solid electrolyte layer; a first electrode layer that is provided on a first main face of the oxide-based solid electrolyte layer and includes a positive electrode active material; and a second electrode layer that is provided on a second main face of the oxide-based solid electrolyte layer and any of the above-mentioned negative electrode active materials.

In the above-mentioned all solid battery, an average grain diameter of the negative electrode active material in the second electrode layer may be 0.5 μm or more and 5 μm or less.

### Effects of the Invention

According to the present invention, it is possible to provide a negative electrode active material that is capable of operating at a sufficiently low potential, has both high volume specific capacity and good cycle characteristics, can be co-fired with a solid electrolyte in a wide firing temperature range and is suitable for an all solid battery using an oxide-based solid electrolyte and to provide an all solid battery using the negative electrode active material.

### BRIEF DESCRIPTION OF THE DRAWINGS

FIG. 1 is a schematic cross-sectional view illustrating a basic structure of an all solid battery;

FIG. 2 illustrates a schematic cross section of an all solid battery of an embodiment;

FIG. 3 illustrates a schematic cross section of another all solid battery,

FIG. 4 illustrates a flowchart of a manufacturing method of an all solid battery;

FIG. 5A and FIG. 5B illustrate a stacking process;

FIG. 6 illustrates a result of charging/discharging test of Example 1;

FIG. 7 illustrates a result of charging/discharging test of Example 2;

FIG. 8 illustrates a result of charging/discharging test of Example 3;

FIG. 9 illustrates a result of charging/discharging test of Comparative example 1;

FIG. 10 illustrates a result of charging/discharging test of Comparative example 2;

FIG. 11A illustrates a dQ/dV curve of Example 2;

FIG. 11B illustrates a dQ/dV curve of Comparative example 3;

FIG. 12A illustrates a charge/discharge curve of Example 2; and

FIG. 12B illustrates a charge/discharge curve of Comparative example 2.

### BEST MODES FOR CARRYING OUT THE INVENTION

A description will be given of an embodiment with reference to the accompanying drawings.

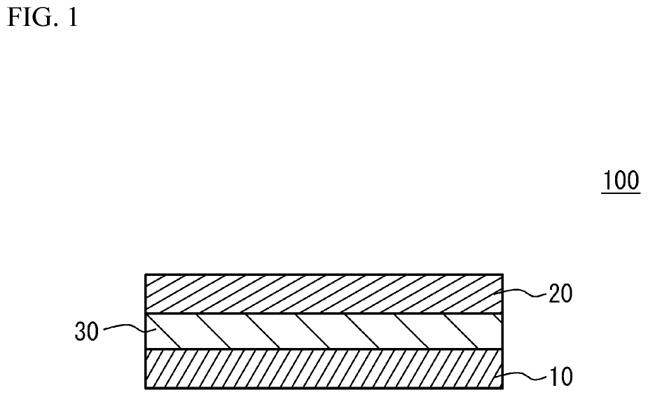

(Embodiment) FIG. 1 is a schematic cross-sectional view illustrating the basic structure of an all solid battery 100. As illustrated in FIG. 1, the all solid battery 100 has a structure in which a solid electrolyte layer 30 is sandwiched between a first internal electrode 10 (first electrode layer) and a second internal electrode 20 (second electrode layer). The first internal electrode 10 is formed on a first main face of the solid electrolyte layer 30. The second internal electrode 20 is formed on the second main face of the solid electrolyte layer 30.

When the all solid battery 100 is used as a secondary battery, one of the first internal electrode 10 and the second internal electrode 20 is used as a positive electrode, and the other is used as a negative electrode. In this embodiment, as an example, the first internal electrode 10 is used as a positive electrode, and the second internal electrode 20 is used as a negative electrode.

The solid electrolyte layer 30 has a solid electrolyte having ionic conductivity as a main component. The solid electrolyte of the solid electrolyte layer 30 is, for example, an oxide-based solid electrolyte having lithium ion conductivity. The solid electrolyte is, for example, a phosphate solid electrolyte having a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like.

The first internal electrode 10 used as a positive electrode includes a material having an olivine type crystal structure, as an electrode active material. It is preferable that the second internal electrode 20 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above- mentioned chemical formula, may be used. A ratio of Li or PO₄ may fluctuate in accordance with a valence. It is preferable that Co, Mn, Fe, Ni or the like is used as the transition metal.

The second internal electrode 20 includes a negative electrode active material.

In the forming process of the first internal electrode 10 and the second internal electrode 20, moreover, oxide-based solid electrolyte material or a conductive material (conductive auxiliary agent) such as a carbon material or a metal material may be added. When the material is evenly dispersed into water or organic solution together with binder or plasticizer, paste for electrode layer is obtained. In the embodiment, a carbon material is used as the conductive auxiliary agent. A metal material may be used as the auxiliary agent, in addition to the carbon material. Pd, Ni, Cu, or Fe, or an alloy thereof may be used as the metal material of the conductive auxiliary agent. For example, the electrolyte of the first internal electrode 10 and the second internal electrode 20 may be the same as the main component solid electrolyte of the solid electrolyte layer 30.

In this embodiment, a TiM₂O₇-based oxide having a monoclinic structure is used as the negative electrode active material. TiM₂O₇-based oxide has a low negative electrode operating potential, small volume changes during charging and discharging, and good cycle characteristics. Although the weight specific capacity is low, the volume specific capacity is relatively high. Therefore, TiM₂O₇-based oxide is a negative electrode active material suitable for a small-sized all solid batteries in which battery weight is not a big concern. This is a negative electrode active material suitable for small-sized all solid batteries. Generally, TiNb₂O₇ using Nb as M is widely known. However, when TiNb₂O₇ is used, cycle stability becomes low.

Therefore, in this embodiment, a TiM1₂₋ₓM₂ₓO₇-based oxide in which M1 is Ta is used as the negative electrode active material. Specifically, an oxide represented by the compositional formula TiTa₂₋ₓM₂ₓO₇ is used as the negative electrode active material. M2 may contain at least one of Nb, V, W, and Mo, and x may be 0.

However, if the value of x is too large, there is a risk of deterioration in cycle characteristics. Therefore, in this embodiment, x is set to less than 0.20. From the viewpoint of suppressing deterioration in cycle characteristics, the smaller x is, the more preferable. For example, x is preferably 0.15 or less, more preferably 0.10 or less, and even more preferably 0.

Here, in general, Nb tends to cause a two-electron reaction (Nb⁵⁺43 Nb⁴⁺→Nb³⁺), so it is thought that the volume change associated with Li insertion and desorption becomes large, which tends to cause deterioration of cycle characteristics. However, Ta is considered to be less likely to cause the two-electron reaction than Nb. Therefore, by using a negative electrode active material that can be expressed by the composition formula TiTa₂₋ₓMₓO₇ (x<0.20), the volume change due to Li insertion and desorption can be suppressed to a small level, resulting in good cycle characteristics.

The ratio Ti/(Ta+M) between Ti and (Ta+M) does not need to be 0.5. However, if Ti/(Ta+M) is low, a secondary phase tends to appear and there is a risk that the capacity will decrease. Therefore, a lower limit is set for Ti/(Ta+M). In this embodiment, Ti/(Ta+M) is 0.5 or more. From the viewpoint of suppressing the appearance of secondary phases, Ti/(Ta+M) is preferably greater than 0.5, more preferably 0.505 or more, and even more preferably 0.510 or more. On the other hand, when Ti/(Ta+M) is high, secondary phases tend to appear, and there is a possibility that cycle characteristics may deteriorate. Therefore, an upper limit is set for Ti/(Ta+M). In this embodiment, Ti/(Ta+M) is 0.56 or less. From the viewpoint of suppressing deterioration of cycle characteristics, Ti/(Ta+M) is preferably 0.55 or less, more preferably 0.54 or less. Note that Ti/(Ta+M) can be defined, for example, as the ratio of the number of atoms, and in LA-ICP-MS (laser ablation ICP mass spectrometry), it is defined as the ratio of the number of counts. Ti/(Ta+M) can be verified from the product after sintering (after densification).

In addition, by using a negative electrode active material that can be expressed by the composition formula TiTa₂₋ₓMₓO₇ (x<0.20), mutual diffusion reaction when co-sintering the solid electrolyte layer 30 and the second internal electrode 20 is suppressed. This is because oxides containing Ta as a main element are relatively stable, and elemental diffusion between solid electrolytes is difficult to occur when co-firing is performed.

In the second internal electrode 20, if the average grain size of the negative electrode active material is too large, the internal resistance of the electrode may increase, making high-speed charging and discharging difficult. If the average grain size is too small, not only the reactivity during heat treatment will increase, but also the sintering and densification of the solid electrolyte may be inhibited. Therefore, the average grain size of the negative electrode active material in the second internal electrode 20 is preferably 0.5 μm or more and 5 μm or less, more preferably 0.7 μm or more and 3.0 μm or less, and even more preferably 1 μm or more and 2 μm or less.

In the dQ/dV curve of the negative electrode active material in the second internal electrode 20, it is preferable that there are capacitive components in the two potential ranges of 1.1V or more and 1.2V or more vs. Li/Li⁺, and 1.6V or more and 1.8V or less vs. Li/Li⁺. A negative electrode active material provided with such two-stage capacity components has voltage selectivity when used as a negative electrode of a battery. Further, when used only in a low potential region, since Ti always exists in a reduced state, the electronic conductivity of the active material improves, and charging and discharging at a higher rate becomes possible.

In manufacturing the all solid battery 100, a multilayer capacitor type structure in which the first internal electrode 10 and the second internal electrode 20 are alternately stacked in parallel with the solid electrolyte layer 30 interposed in between is suitable for increasing the capacity density and reducing the size. At that time, it is preferable that the thickness of the first internal electrode 10 and the thickness of the second internal electrode 20 be approximately the same, but the negative electrode active material provided by this embodiment has a capacity per volume higher than that of a general positive electrode active material. Therefore, it is preferable to balance the capacity by adding more positive electrode active material than negative electrode active material. Balance can be achieved by reducing the amount of the conductive agent by adding an active material with high electronic conductivity more than the negative electrode active material in volume to the first internal electrode 10 or adding an active material with high ion conductivity more than the negative electrode active material in volume to the first internal electrode 10. It is possible to balance the capacity and electron conductivity by adding LiCoPO₄, which has high electron conductivity after charging, in an amount larger than the volume of the negative electrode active material and making the volume of the conductive additive smaller than that of the negative electrode active material. This is preferable. When the first internal electrode 10 and the second internal electrode 20 have the same thickness, it is necessary to make the volume ratio of the negative electrode active material smaller than the volume ratio of the positive electrode active material in order to balance the capacity. Therefore, the volume ratio of the negative electrode active material in the second internal electrode 20 is 20 to 60 vol. % is preferable.

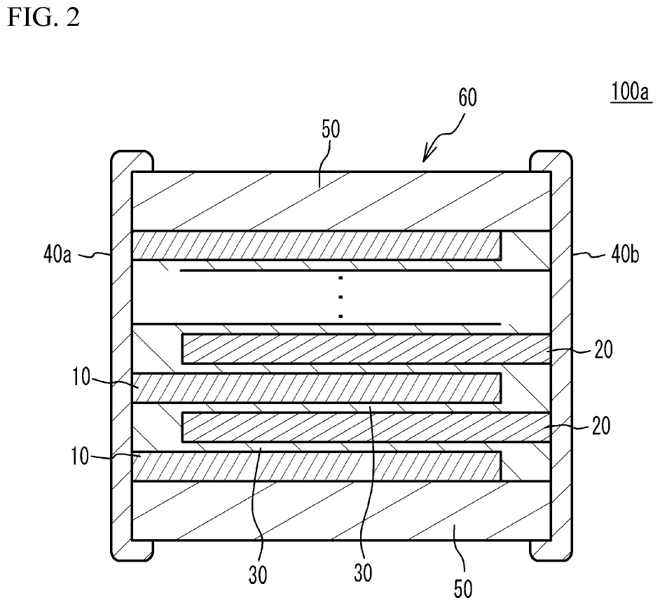

FIG. 2 illustrates a schematic cross section of an all solid battery 100a in which a plurality of cell units are stacked. The all solid battery 100a has a multilayer chip 60 having a rectangular parallelepiped shape. Each of a first external electrode 40a and a second external electrode 40b is provided directly on each of two side faces among four side faces which are other than an upper face and a lower face of the multilayer chip 60 in the stacking direction. The two side faces may be adjacent to each other. Alternatively, the two side faces may be face with each other. In the embodiment, the first external electrode 40a and the second external electrode 40b are provided so as to contact two side faces facing each other (hereinafter referred to as two edge faces).

In the following description, the same numeral is added to each member that has the same composition range, the same thickness range and the same particle distribution range as that of the all solid battery 100. And, a detail explanation of the same member is omitted.

In the all solid battery 100a, each of the first internal electrodes 10 and each of the second internal electrodes 20 sandwich each of the solid electrolyte layer 30 and are alternately stacked. Edges of the first internal electrodes 10 are exposed to the first edge face of the multilayer chip 60 but are not exposed to the second edge face of the multilayer chip 60. Edges of the second internal electrodes 20 are exposed to the second edge face of the multilayer chip 60 but are not exposed to the first edge face. Thus, each of the first internal electrodes 10 and each of the second internal electrodes 20 are alternately conducted to the first external electrode 40aand the second external electrode 40b. The solid electrolyte layer 30 extends from the first external electrode 40a to the second external electrode 40b. In this way, the all solid battery 100a has a structure in which a plurality of cell units are stacked.

A cover layer 50 is stacked on an upper face (in FIG. 2 on the upper face of the uppermost internal electrode) of a stacked structure of the first internal electrode 10, the solid electrolyte layer 30 and the second internal electrode 20. Another cover layer 50 is stacked on a lower face (in FIG. 2, on the lower face of the lowermost internal electrode) of the stacked structure. A main component of the cover layer 50 is an inorganic material such as Al, Zr, Ti (for example, Al₂O₃, ZrO₂, TiO₂ or the like). The main component of the cover layer 50 may be the main component of the solid electrolyte layer 30.

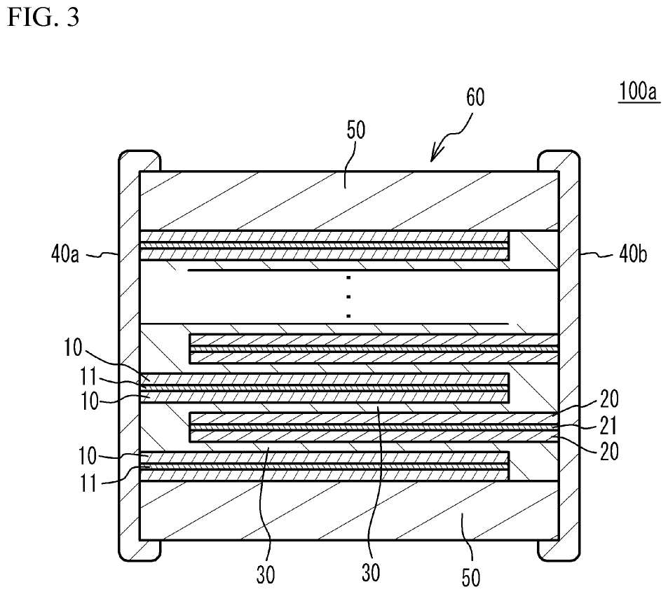

The first internal electrode 10 and the second internal electrode 20 may have an electric collector layer. For example, as illustrated in FIG. 3 a first electric collector layer 11 may be provided in the first internal electrode 10. A second electric collector layer 21 may be provided in the second internal electrode 20. A main component of the first electric collector layer 11 and the second electric collector layer 21 is a conductive material. For example, the conductive material of the first electric collector layer 11 and the second electric collector layer 21 may be such as a metal, carbon or the like. When the first electric collector layer 11 is connected to the first external electrode 40a and the second electric collector layer 21 is connected to the second external electrode 40b, current collecting efficiency is improved.

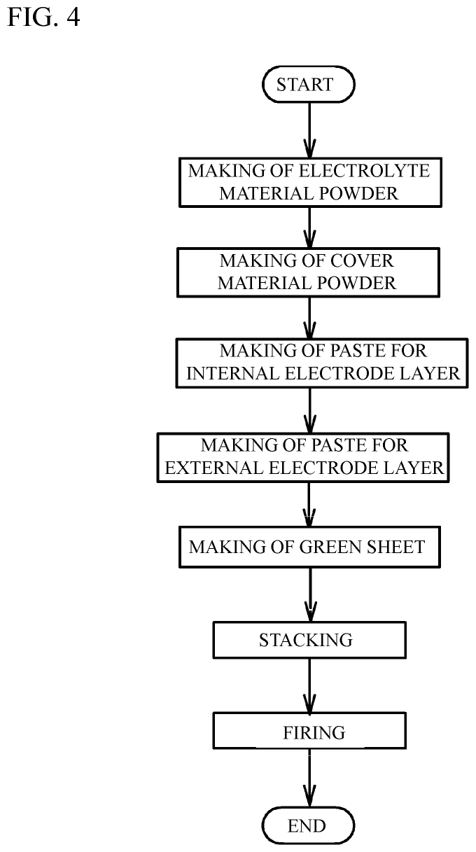

A description will be given of a manufacturing method of the all solid battery 100a illustrated in FIG. 2. FIG. 4 illustrates a flowchart of the manufacturing method of the all solid battery 100a.

(Making process of negative electrode active material powder) Raw materials such as TiO₂ and Ta₂O₅ are weighed and ground and mixed so that TiTa₂₋ₓMₓO₇ (x<0.20) will be formed and Ti/Ta is 0.50 or more and 0.56 or less. After mixing, the mixture is calcined in the atmosphere at 1100° C., and the resulting calcined powder is ground again. Thereafter, the desired synthetic powder of TiTa₂₋ₓMₓO₇ (x<0.20) is obtained by heat treatment at 1300° C. in the air. After the synthetic powder is ground again, the synthetic powder is sieved through a #150 stainless steel mesh to obtain a negative electrode active material powder.

If the firing temperature during synthesis is too high, the particles will strongly adhere to each other, making it difficult to handle, which is not preferable, and if the firing temperature is too low, the uniformity of each metal atom will decrease, which is not preferable. The firing temperature is preferably 1150° C. or more and 1450° C. or less, more preferably 1200° C. or more and 1400° C. or less, and even more preferably 1250° C. or more and 1350° C. or less.

(Making process of raw material powder for solid electrolyte layer) First, raw material powder for the solid electrolyte layer that constitutes the solid electrolyte layer 30 described above is prepared. For example, by mixing raw materials, additives and so on and using a solid-phase synthesis method or the like, a raw material powder of an oxide-based solid electrolyte can be made. By dry pulverizing the obtained raw material powder, it is possible to adjust to a desired average particle size. For example, a planetary ball mill using ZrO₂ balls of 5 mmϕ is used to adjust the desired average particle size.

(Making process of raw material powder for cover layer) First, a ceramics raw material powder that constitutes the cover layer 50 described above is prepared. For example, raw material powder for the cover layer can be made by mixing raw materials, additives and so on and using a solid-phase synthesis method or the like. By dry pulverizing the obtained raw material powder, it is possible to adjust to a desired average particle size. For example, a planetary ball mill using ZrO₂ balls of 5 mmϕ is used to adjust the desired average particle size.

(Making process for internal electrode) Next, an internal electrode paste for forming the above-described first internal electrode 10 and the second internal electrode 20 is made. For example, an internal electrode paste can be obtained by uniformly dispersing a conductive aid, an electrode active material, a solid electrolyte material, a sintering aid, a binder, a plasticizer, and so on in water or an organic solvent. As the solid electrolyte material, the solid electrolyte paste described above may be used. A carbon material or the like is used as the conductive aid. A metal may be used as the conductive aid. Examples of the metal of the conductive aid include Pd, Ni, Cu, Fe, and alloys containing these. Pd, Ni, Cu, Fe, alloys containing these, and various carbon materials may also be used. When the compositions of the first internal electrode 10 and the second internal electrode 20 are different from each other, the respective internal electrode pastes may be prepared separately.

As the sintering aid, for example, any glass component such as Li—B—O based compounds, Li—Si—O based compounds, Li—C—O based compounds, Li—S—O based compounds, and Li—P—O based compounds can be used.

(External electrode paste preparation process) Next, an external electrode paste for forming the first external electrode 40a and the second external electrode 40b is made. For example, an external electrode paste can be obtained by uniformly dispersing a conductive material, a glass frit, a binder, a plasticizer, and the like in water or an organic solvent.

(Forming process of green sheet) A solid electrolyte slurry having a desired average particle size is prepared by uniformly dispersing the raw material powder for the solid electrolyte layer in an aqueous solvent or an organic solvent together with a binder, a dispersant, a plasticizer, and so on followed by wet pulverization. At this time, a bead mill, a wet jet mill, various kneaders, a high-pressure homogenizer, or the like can be used. And it is preferable to use a bead mill from the viewpoint of being able to simultaneously adjust the particle size distribution and disperse. A binder is added to the obtained solid electrolyte slurry to obtain a solid electrolyte paste. By applying the obtained solid electrolyte paste, the solid electrolyte green sheet 51 can be formed. The applying method is not particularly limited. A slot die method, a reverse coating method, a gravure coating method, a bar coating method, a doctor blade method, or the like can be used. The particle size distribution after wet pulverization can be measured, for example, using a laser diffraction measurement device using a laser diffraction scattering method.

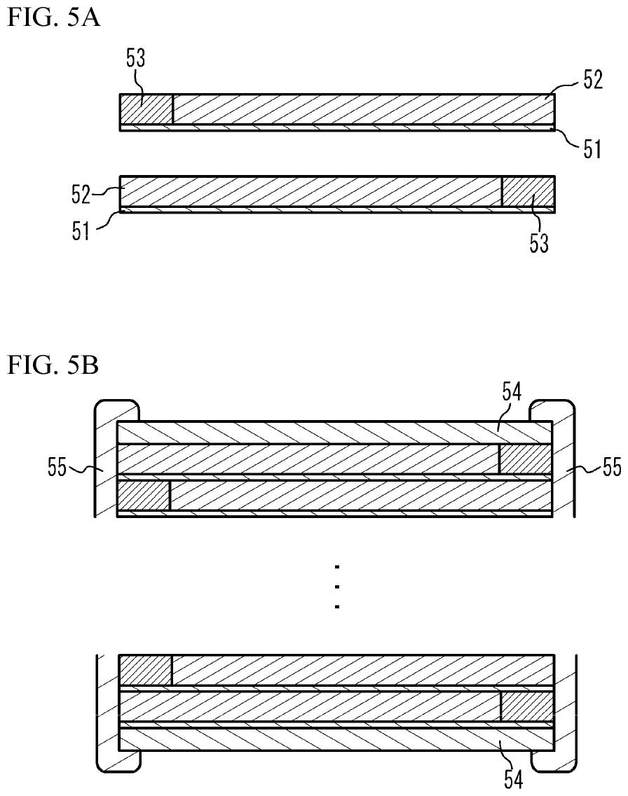

(Stacking process) Paste 52 for internal electrode is printed on one face of the solid electrolyte green sheet 51, as illustrated in FIG. 5A. A thickness of the paste 52 for internal electrode is equal to or more than a thickness of the solid electrolyte green sheet 51. A reverse pattern 53 is printed on a part of the solid electrolyte green sheet 51 where the paste 52 for electrode layer is not printed. A material of the reverse pattern 53 may be the same as that of the solid electrolyte green sheet 51. The solid electrolyte green sheets 51 after printing are stacked so that each of the solid electrolyte green sheets 51 is alternately shifted to each other. As illustrated in FIG. 5B, cover sheets 54 are clamped from an upper side and a lower side of the stacking direction. Thus, a multilayer structure is obtained. In this case, in the multilayer structure, each of the paste 52 for internal electrode is alternately exposed to the two end faces. The cover sheet 54 is formed by printing the material powder for cover layer with the same method as the forming of the solid electrolyte green sheet. The thickness of the cover sheet 54 is larger than the thickness of the solid electrolyte green sheet 51. The cover sheet 54 may be thickened during printing of the cover sheet 54. The cover sheet 54 may be thickened by stacking t plurality of the printed sheets.

Next, the two end faces are coated with paste 55 for external electrode by dipping method or the like. After that, the paste 55 for external electrode is dried. Thus, a compact for forming the all solid battery 100a is obtained.

(Firing process) Next, the obtained multilayer structure is fired. The firing conditions are oxidizing atmosphere or non-oxidizing atmosphere, and the maximum temperature is preferably 400° C. to 1000° C., more preferably 500° C. to 900° C., without any particular limitation. A step of holding below the maximum temperature in an oxidizing atmosphere may be provided to sufficiently remove the binder until the maximum temperature is reached. In order to reduce process costs, it is desirable to perform the firing at as low a temperature as possible. After firing, re-oxidation process may be performed. Through the above steps, the all solid battery 100a is produced.

The internal electrode paste, a current collector paste containing the conductive material, and the internal electrode paste may be sequentially stacked to form current collector layers in the first internal electrode 10 and the second internal electrode 20.

### EXAMPLES

All solid batteries were produced according to the embodiments, and their characteristics were investigated.

(Example 1) TiO₂ and Ta₂O₅ as raw materials were weighed at a molar ratio of 1:1and mixed by grinding so as to have a composition ratio of TiTa₂O₇. After mixing, the mixture was calcined at 1100°° C. in the air, and the resulting calcined powder was ground again, and further heat-treated at 1300°° C. in the air to obtain the desired TiTa₂O₇ synthetic powder. After the synthetic powder was ground again, the synthetic powder was sieved through a #150stainless steel mesh to obtain a negative electrode active material powder. The same diffraction peak as TiTa₂O₇ was observed from the XRD measurement, and no other secondary phase peaks were observed.

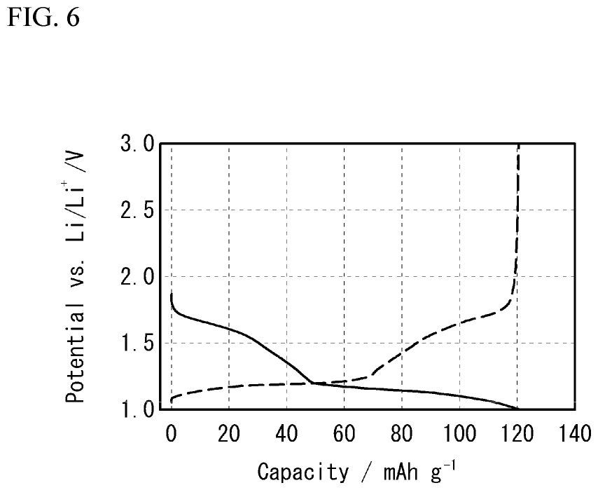

A coating slurry consisting of negative electrode active material powder, PVdF binder, acetylene black, and NMP was prepared, a coating film was formed on copper foil, and a negative electrode half cell with metal lithium foil placed on the counter electrode was sealed in a 2032 coin cell. A charge/discharge test was conducted at 25° C. and a charge/discharge rate of 0.1 C in the range of 3 to 1 V. FIG. 6 shows the results of the charge/discharge test.

The initial discharge capacity at 1.0V cutoff was 120 mAh/g. The discharge capacity after 20 cycles was 97.5% of the initial discharge capacity. When an experiment was conducted in which this negative electrode active material was mixed with the solid electrolyte LAGP at a volume ratio of 50:50 and heat treated in the air, no secondary phase was observed up to 730° C.

(Example 2) A negative electrode active material powder was prepared with the same procedure as in Example 1, except that the raw materials TiO₂ and Ta₂O₅ were weighed at a molar ratio of 1.06:1 so that the composition ratio was Ti_{1.06}Ta₂O_{7.12} (Ti/Ta=0.530). And the negative electrode active material powder was evaluated. The same diffraction peak as TiTa₂O₇ was observed from the XRD measurement, and no other secondary phase peaks were observed.

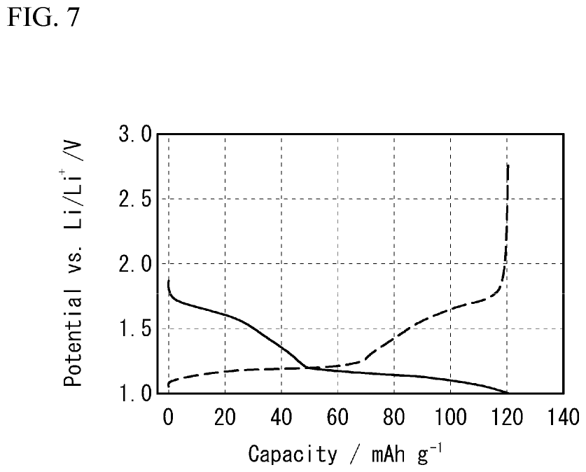

A coating slurry consisting of negative electrode active material powder, PVdF binder, acetylene black, and NMP was prepared, a coating film was formed on copper foil, and a negative electrode half cell with metal lithium foil placed on the counter electrode was sealed in a 2032 coin cell. A charge/discharge test was conducted at 25° C. and a charge/discharge rate of 0.1 C in the range of 3 to 1 V. FIG. 7 shows the results of the charge/discharge test.

The initial discharge capacity at 1.0V cutoff was 121 mAh/g. The discharge capacity after 20 cycles was 99.7% of the initial discharge capacity. When an experiment was conducted in which this negative electrode active material was mixed with the solid electrolyte LAGP at a volume ratio of 50:50 and heat treated in the air, no secondary phase was observed up to 730° C.

(Example 3) A negative electrode active material powder was prepared with the same procedure as in Example 1, except that the raw materials TiO₂ and Ta₂O₅ were weighed at a molar ratio of 1.12:1 so that the composition ratio was Ti_{1.12}Ta₂O_{7.24} (Ti/Ta=0.560). And the negative electrode active material powder was evaluated. The same diffraction peak as TiTa₂O₇ was observed from the XRD measurement, and other secondary phase peaks were also observed.

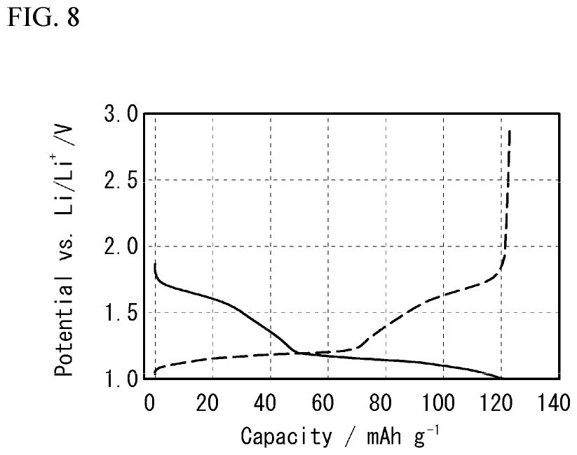

A coating slurry consisting of negative electrode active material powder, PVdF binder, acetylene black, and NMP was prepared, a coating film was formed on copper foil, and a negative electrode half cell with metal lithium foil placed on the counter electrode was sealed in a 2032 coin cell. A charge/discharge test was conducted at 25° C. and a charge/discharge rate of 0.1 C in the range of 3 to 1 V. FIG. 8 shows the results of the charge/discharge test.

The initial discharge capacity at 1.0V cutoff was 123 mAh/g. The discharge capacity after 20 cycles was 96.8% of the initial discharge capacity. When an experiment was conducted in which this negative electrode active material was mixed with the solid electrolyte LAGP at a volume ratio of 50:50 and heat treated in the air, no secondary phase was observed up to 730° C.

(Comparative example 1) A negative electrode active material powder was prepared with the same procedure as in Example 1, except that the raw materials TiO₂ and Ta₂O₅ were weighed at a molar ratio of 0.97:1 so that the composition ratio was Ti_{0.97}Ta₂O_{6.94} (Ti/Ta=0.485). And the negative electrode active material powder was evaluated. The same diffraction peak as TiTa₂O₇ was observed from the XRD measurement, and other secondary phase peaks were also observed.

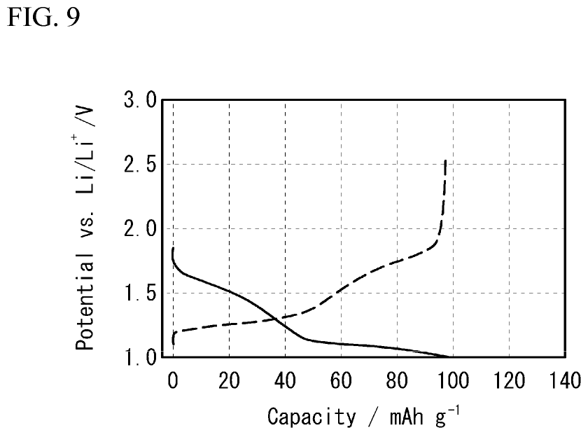

A coating slurry consisting of negative electrode active material powder, PVdF binder, acetylene black, and NMP was prepared, a coating film was formed on copper foil, and a negative electrode half cell with metal lithium foil placed on the counter electrode was sealed in a 2032 coin cell. A charge/discharge test was conducted at 25° C. and a charge/discharge rate of 0.1 C in the range of 3 to 1 V. FIG. 9 shows the results of the charge/discharge test.

The initial discharge capacity at 1.0V cutoff was 98 mAh/g. The discharge capacity after 20 cycles was 86.3% of the initial discharge capacity. When an experiment was conducted in which this negative electrode active material was mixed with the solid electrolyte LAGP at a volume ratio of 50:50 and heat treated in the air, no secondary phase was observed up to 730° C.

(Comparative example 2) A negative electrode active material powder was prepared with the same procedure as in Example 1, except that the raw materials TiO₂ and Ta₂O₅ were weighed at a molar ratio of 1.18:1 so that the composition ratio was Ti_{1.18}Ta₂O_{7.36}. And the negative electrode active material powder was evaluated. The same diffraction peak as TiTa₂O₇ was observed from the XRD measurement, and other secondary phase peaks were also observed.

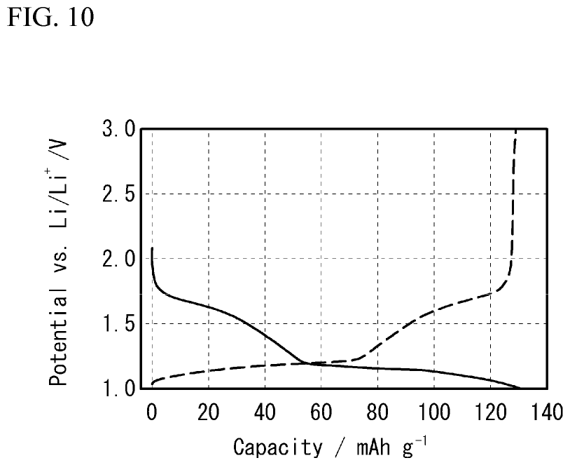

A coating slurry consisting of negative electrode active material powder, PVdF binder, acetylene black, and NMP was prepared, a coating film was formed on copper foil, and a negative electrode half cell with metal lithium foil placed on the counter electrode was sealed in a 2032 coin cell. A charge/discharge test was conducted at 25° C. and a charge/discharge rate of 0.1 C in the range of 3 to 1 V. FIG. 10 shows the results of the charge/discharge test.

The initial discharge capacity at 1.0V cutoff was 129 mAh/g. The discharge capacity after 20 cycles was 93.3% of the initial discharge capacity. When an experiment was conducted in which this negative electrode active material was mixed with the solid electrolyte LAGP at a volume ratio of 50:50 and heat treated in the air, no secondary phase was observed up to 730° C.

The results of Examples 1 to 3 and Comparative Examples 1 and 2 are summarized in Table 1. When a secondary phase was confirmed, it was judged as slightly good “Δ”. If no secondary phase was confirmed, it was judged as good “o”. If the initial discharge capacity was 110 mAh/g or more, it was judged as good “o”. If the initial discharge capacity was 100mAh/g or less, it was judged as bad “x”. If the discharge capacity after 20 cycles with respect to the initial discharge capacity was 95% or more, it was judged as good “o”, if it was 90% or more and less than 95%, it was judged as slightly good “o”, and if it was less than 90%, it was judged as bad “x”. If the maximum temperature at which no secondary phase was generated during heat treatment with the solid electrolyte is 700° C. or higher, it was judged as good “o”, and if it was 650° C. or more and lower than 700° C., it was judged as good “o”, and if it was less than 650° C., it was judged as bad “x”.

An overall judgment was made based on the five indicators. “o” is 2 points. “Δ” is point. “x” is 0 points. Thus, s score is assigned to the evaluation for each item. If the total score was 0 to 6, the overall judgment was bad “x”, and if the total score was 7 to 9, the overall judgement was good “o”. The above results are summarized in Table 1.

TABLE 1

| | | | | | | MAX | |
|---|---|---|---|---|---|---|---|
| | | | | | | TEMPERATURE | |
| | | | | | | WHERE NO | |
| | | | | | CYCLE | SECONDARY | |
| | | | SECONDARY | CAPACITY | CHARAC- | PHASE IS | OVERALL |
| | COMPOSITION | Ti/Ta | PHASE | (mAh/g) | TERISTIC | GENERATED | JUDGEMENT |
| EXAMPLE 1 | TiTa₂O₇ | 0.500 | NONE (◯) | 120 (◯) | 97.5% (◯) | 730° C. (◯) | ◯ |
| EXANPLE 2 | Ti_{1.06}Ta₂O_{7.12} | 0.530 | NONE (◯) | 121 (◯) | 99.7% (◯) | 730° C. (◯) | ◯ |
| EXAMPLE 3 | Ti_{1.12}Ta₂O_{7.24} | 0.560 | EXIST (Δ) | 123 (◯) | 96.8% (◯) | 730° C. (◯) | ◯ |
| COMPARATIVE | Ti_{0.97}Ta₂O_{6.94} | 0.485 | EXIST (Δ) | 98 (X) | 86.3% (X) | 730° C. (◯) | X |
| EXAMPLE 1 | | | | | | | |
| COMPARATIVE | Ti_{1.18}Ta₂O_{7.36} | 0.590 | EXIST (Δ) | 129 (◯) | 93.3% (Δ) | 730° C. (◯) | X |
| EXAMPLE 2 | | | | | | | |

(Comparative example 3) A negative electrode active material powder was prepared with the same procedure as in Example 1, except that the raw materials TiO₂ and Nb₂O₅ were weighed at a molar ratio of 1:1 so that the composition ratio was TiNb₂O₇. And the negative electrode active material powder was evaluated.

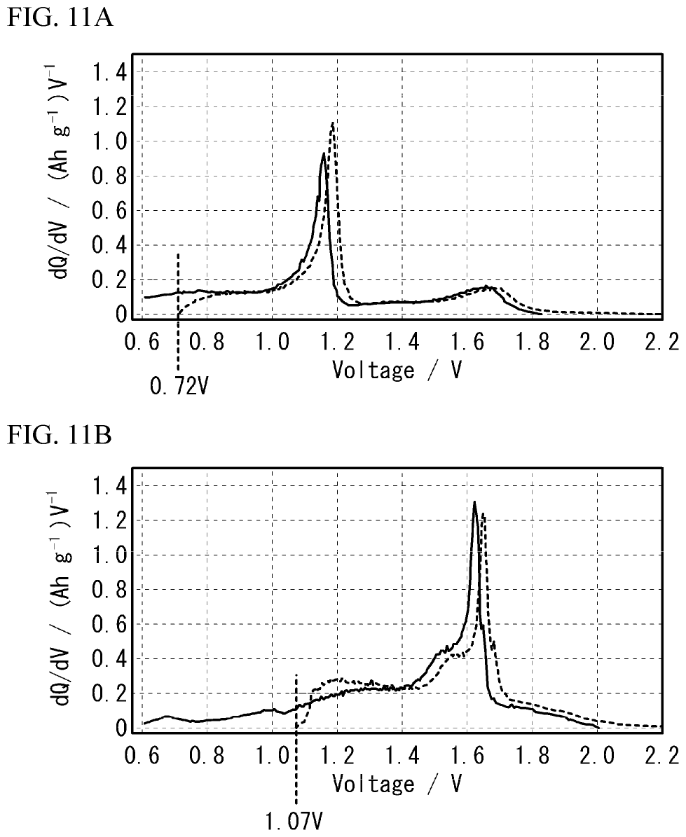

FIG. 11A is a diagram showing a dQ/dV curve for Example 2 when CC charging and discharging at a rate of 0.1C was performed to a lower limit voltage of 0.6V. FIG. 11B is a diagram showing a dQ/dV curve for Comparative Example 3 when CC charging and discharging at a rate of 0.1C was performed to a lower limit voltage of 0.6V. The solid line is the charging curve, and the dotted line is the discharging curve. From the results in FIG. 11A, in the dQ/dV curve, it can be seen that there are capacitive components in the two potential ranges of 1.1V or more and 1.2V or more vs. Li/Li⁺, and 1.6V or more and 1.8V or less vs. Li/Li⁺.

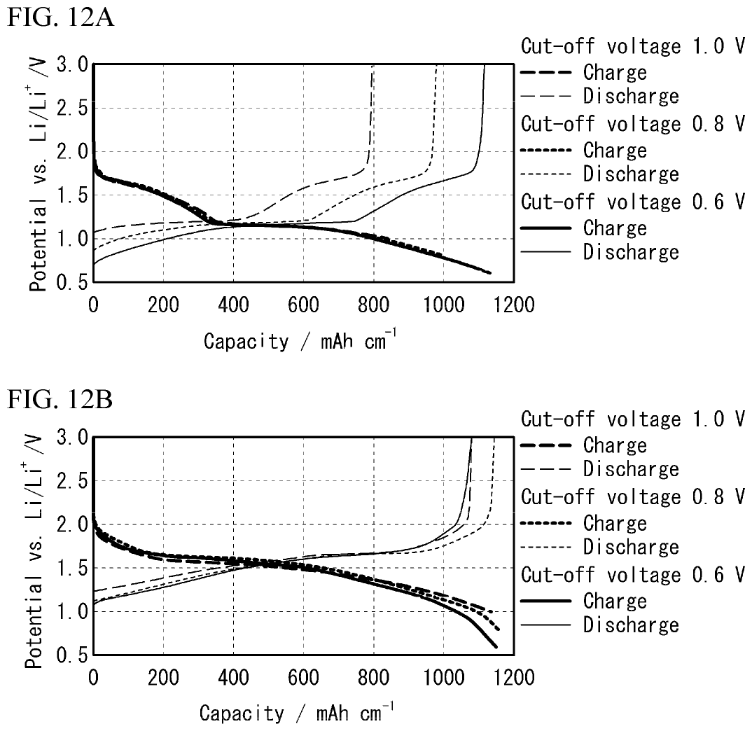

FIG. 12A is a diagram showing the charge/discharge curves of Example 2 at 1.0V cutoff, 0.8V cutoff, and 0.6V cutoff. FIG. 12B is a diagram showing charge/discharge curves for Comparative Example 3 at 1.0V cutoff, 0.8V cutoff, and 0.6V cutoff. Comparing FIG. 12A and FIG. 12B, in Comparative Example 3, the voltage at the start of discharge is 1.0V or more, but in Example 2, the voltage at the start of discharge is around 0.7V. Therefore, it can be seen that in Example 2, operation is possible even in a low potential region of up to 0.7V. This is considered to be due to the use of Ta instead of Nb, and therefore it is considered that Examples 1 and 3 can similarly operate in the low potential region.

Although the embodiments of the present invention have been described in detail, it is to be understood that the various change, substitutions, and alterations could be made hereto without departing from the spirit and scope of the invention.

1. A negative electrode active material expressed by a composition formula of TiTa₂₋ₓMₓO₇, wherein:
x is 0 or more and less than 0.20;
M is at least one of Nb, V, W and Mo; and
Ti/(Ta+M) molar ratio is 0.53 or more and 0.56 or less.

2. The negative electrode active material as claimed in claim 1,
wherein the negative electrode active material has a monoclinic structure belonging to a space group l2/m.

3. The negative electrode active material as claimed in claim 1,
wherein there are capacitive components in two potential ranges of 1.1V or more and 1.2V or more vs. Li/Li⁺, and 1.6V or more and 1.8V or less vs. Li/Li⁺.

4. The negative electrode active material as claimed in claim 1,
wherein x is 0.

5. An all solid battery comprising:
an oxide-based solid electrolyte layer;
a first electrode layer that is provided on a first main face of the oxide-based solid electrolyte layer and includes a positive electrode active material; and
a second electrode layer that is provided on a second main face of the oxide-based solid electrolyte layer and a negative electrode active material as claimed in claim 1.

6. The all solid battery as claimed in claim 5,
wherein an average grain diameter of the negative electrode active material in the second electrode layer is 0.5 μm or more and 5 μm or less.
